(19) United States
(12) Patent Application Publication
(10) Pub. No.: US 2014/0188739 A1
(43) Pub. Date: Jul. 3, 2014

(54) METHOD FOR OUTPUTTING CONVERGENCE INDEX

(71) Applicant: Korea Institute of Industrial Technology, Cheonan-si, Chungcheongnam-do (KR)

(72) Inventors: Nak Kyu Lee, Incheon (KR); Hye Jin Lee, Incheon (KR); Jung Han Song, Uiwang-si (KR); Jeanho Park, Ansan-si (KR); Sung Min Bae, Seoul (KR); Hyoung Wook Lee, Chungju-si (KR); Chul Young Kim, Seoul (KR)

(73) Assignee: KOREA INSTITUTE OF INDUSTRIAL TECHNOLOGY, Cheonan-si, Chungcheongnam-do (KR)

(21) Appl. No.: 14/116,045

(22) PCT Filed: Dec. 30, 2011
(86) PCT No.: PCT/KR2011/010392

§ 371 Date: Feb. 10, 2014

(30) Foreign Application Priority Data
May 9, 2011 (KR) 10-2011-0043316

(51) Int. Cl. G06Q 50/18; G06Q 10/10

(52) U.S. Cl. CPC G06Q 50/184; G06Q 10/10
USPC 705/310

(57) ABSTRACT

The present invention relates to a method for outputting a convergence index, and more particularly, to a method for outputting a convergence index by utilizing patent information. According to the method for outputting the convergence index of the present invention, the convergence index can be outputted by using time information related to a patent which is included in a patent group, a patent classification, and an industrial classification that corresponds to the patent classification. The method for outputting the convergence index of the present invention systematically outputs the convergence index by using patent data, which is objective data, thereby outputting the convergence index which is objective and appropriate.

### CROSS-REFERENCE TO RELATED APPLICATIONS

This application is a national stage of International Application No. PCT/KR2011/010392, filed Dec. 30, 2011, which claims the benefit of Korean Application No. 10-2011-0043316, filed May 9, 2011, in the Korean Intellectual Property Office. All disclosures of the document(s) named above are incorporated herein by reference.

### BACKGROUND OF THE INVENTION

1. Field of the Invention

The present invention relates to a method for calculating a convergence index, and more particularly, to a method for calculating a convergence index utilizing patent information.

2. Description of the Related Art

With the start of the 21st century, convergence between homogeneous and heterogeneous fields such as technology and technology, product and service, service and service, or the like over all industrial areas has accelerated. The term “convergence” has started to be used in such a manner that combination of communication, broadcasting, and media has been predicted by Professor Negroponte of MIT and the predicted combination has been examined in academia.

For example, over the course of the 1990s, all industrial areas developed into IT convergence in which IT is combined.

With the start of the 21st century, the United States, the EU, Japan, and the like have expanded R&D and investment with respect to convergence technologies, and various types of convergence have exponentially increased. The United States set convergence of bio technologies, information technologies, and cognitive science based on nano technologies as the national agenda, and the EU aims for convergence of a wide range of disciplines and technologies as well as convergence of nano, bio, information, and cognitive (NBIC) technologies.

In this manner, convergence has been established as the global agenda in the world, and in Korea, according to such global trends, the “Industrial Convergence Promotion Act” was passed in the National Assembly on April 2011, and became effective in October 2011.

However, despite such trends of convergence, a clear and highly valid convergence index which quantifies the degree of convergence has not been developed, and therefore there are urgent needs to develop an objective and reasonable convergence index.

### SUMMARY OF THE INVENTION

Additional aspects and/or advantages of the invention will be set forth in part in the description which follows and, in part, will be obvious from the description, or may be learned by practice of the invention.

### Technical Problem to be Solved

The present invention is directed to a method for calculating an objective convergence index by utilizing patent data.

Specifically, the present invention is directed to a method for calculating a convergence index in order to calculate a capability development index, a capability convergence index, and an industry relation index which constitute a convergence index.

### Technical Solution

According to an aspect of the present invention, there is provided A method for calculating a convergence index by a convergence index service system configured to provide the convergence index to a user computer through a wired network or a wireless network, the method including: (a) receiving a patent group including at least two patents from the user computer; (b) acquiring time information, a patent classification and an industrial classification corresponding to the patent classification related to each of the at least two patents in the patent group; (c) calculating a capability development index based on the time information and patent classification acquired in the step (b); (d) calculating a capability convergence index based on the patent classification acquired in the step (b); and (e) calculating an industry relation index based on the patent classification and the industrial classification acquired in the step (b), wherein the step (e) includes calculating the industry relation index using a relation score of heterogeneous industries and a relation score of homogeneous industries calculated based on the patent classification and the industrial classification.

The step (e) may include: (e-1) calculating an industrial distribution ratio based on the industrial classification; (e-2) selecting at least two of the industrial classification according to number of patents related to the industrial classification; (e-3) calculating a degree of technological convergence based on the number of patents related to the industrial classifications selected in the step (e-2); and (e-4) calculating the relation score of heterogeneous industries based on the industrial distribution ratio and the degree of technological convergence.

The step (e) may include: (e-5) selecting at least two of the industrial classification according to number of patents related to the industrial classification; (e-6) calculating a technological distribution ratio based on the number of patents related to the industrial classification selected in the step (e-5); (e-7) calculating a technological occupation ratio based on number of patent classifications including the patent related to the industrial classification selected in the step (e-5); and (e-8) calculating the relation score of homogeneous industries based on the technological distribution ratio and the technological occupation ratio.

The step (e-7) may include normalizing the technological occupation ratio based on a correction coefficient of the technological occupation ratio.

The step (c) may include calculating the capability development index using a capability score and a time score calculated based on the time information and the patent classification.

The step (c) may include: (c-1) calculating number of patents per unit time for the patent group based on unit time and the time information; (c-2) calculating number of new technology-related patents per unit time based on the patent classification and unit time; and (c-3) calculating the capability score based on the number of patents per unit time and the number of new technology-related patents per unit time.

The step (c) may include: (c-4) calculating cumulative number of patents per unit time for the patent group based on unit time and the time information; (c-5) calculating a cumulative reference time point related to the cumulative number of patents per unit time; and (c-6) calculating the time score based on the cumulative reference time point.

The step (d) may include calculating the capability convergence index using a capability convergence score and a service score calculated based on the patent classification.

The step (d) may include: (d-1) calculating number of the patent classification related to one of the at least two single patents; (d-2) acquiring weights of the number of patent classification; and (d-3) calculating the capability convergence score based on the number of patent classification and the weights of the number of patent classification.

The step (d) may include: (d-4) transmitting a service classification group including at least two services to the user computer; (d-5) receiving selection information including information on a service selected from the service classification group from the user computer; and (d-6) calculating the service score based on the selection information.

It is possible that the patent classification is determined according to a predetermined depth in a patent classification system including the patent classification.

It is possible that the capability development index is calculated based on a main patent classification of the patent classification, the capability convergence index is calculated based on a sub patent classification and the main patent classification, and the industry relation index is calculated based on the main patent classification.

### Advantageous Effects

The method for calculating the convergence index according to the present invention has the following effects.

First, according to the method for calculating the convergence index according to an embodiment of the present invention, the convergence index is systematically calculated using patent data, which is objective data, thereby calculating the convergence index which is objective and appropriate.

Second, when utilizing the method for calculating the convergence index according to the present invention, convergence indexes among products, industries, companies, technologies, and the like may be systematically and rapidly calculated.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a structural diagram showing a relationship between a detailed convergence index and a sub element score which are included in a convergence index according to an embodiment of the present invention;

FIG. 2 is a flowchart showing a method for calculating a convergence index according to an embodiment of the present invention;

FIG. 3 is a flowchart showing an example of calculating a capability score in operation S300 according to an embodiment of the present invention;

FIG. 4 is a flowchart showing an example of calculating a time score in operation S300 according to an embodiment of the present invention;

FIG. 5 is a flowchart showing an example of calculating a capability convergence score in operation S400 according to an embodiment of the present invention;

FIG. 6 is a flowchart showing an example of calculating a service score in operation S400 according to an embodiment of the present invention;

FIG. 7 is a flowchart showing an example of calculating a relation score of heterogeneous industries in operation S500 according to an embodiment of the present invention;

FIG. 8 is a flowchart showing an example of calculating a relation score of homogeneous industries in operation S500 according to an embodiment of the present invention;

FIG. 9 is a graph showing an example of a process for calculating a capability score according to an embodiment of the present invention; and

FIG. 10 is a graph showing an example of a process for calculating a time score according to an embodiment of the present invention.

### DETAILED DESCRIPTION OF THE EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

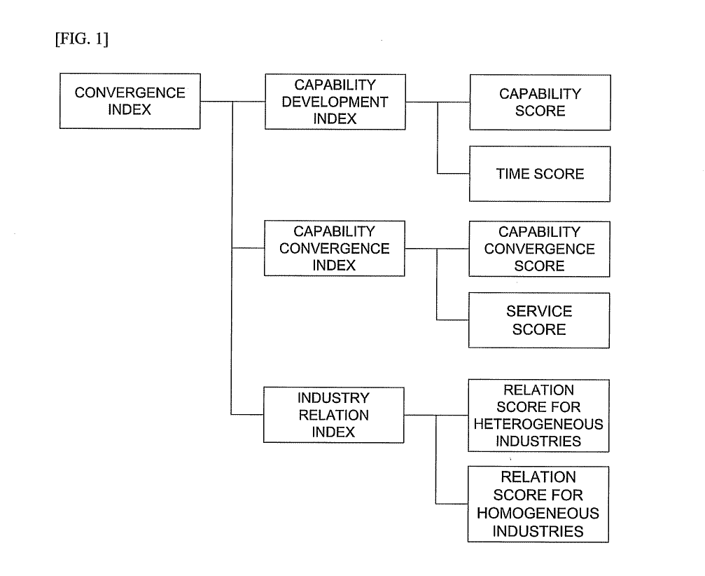

FIG. 1 is a structural diagram showing a relationship between a detailed convergence index and a sub element score which are included in a convergence index according to an embodiment of the present invention.

Referring to FIG. 1, the convergence index includes three detailed convergence indexes such as a capability development index, a capability convergence index, and an industry relation score. In addition, the capability development index is calculated based on a capability score and a time score, the capability convergence index is calculated based on a capability convergence score and a service score, and the industry relation index is calculated based on a relation score of heterogeneous industries and a relation score of homogeneous industries.

Hereinafter, a method for calculating three detailed convergence indexes will be described in detail.

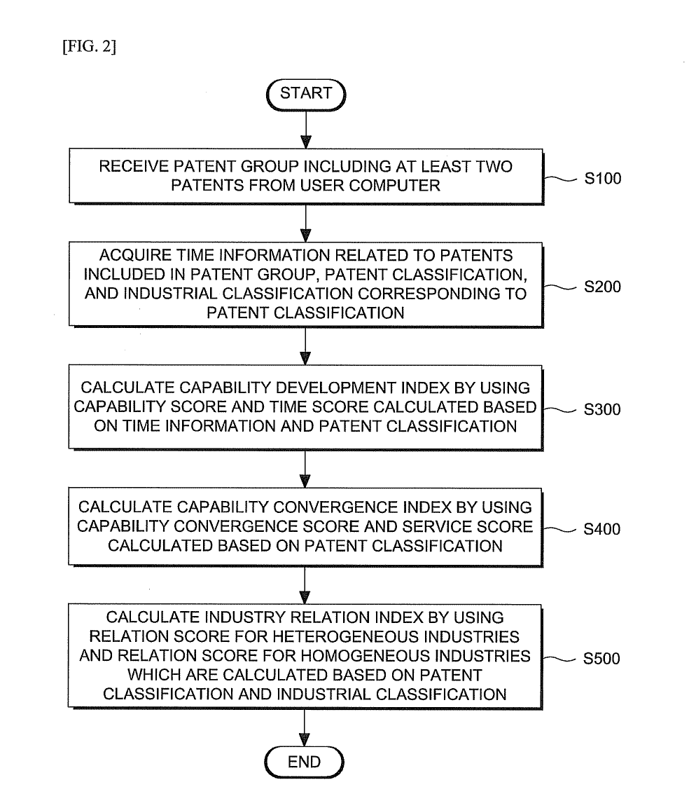

FIG. 2 is a flowchart showing a method for calculating a convergence index according to an embodiment of the present invention.

Referring to FIG. 2, first, in operation S100, the method includes receiving a patent group including at least two patents from a user computer.

The patent group may be obtained by removing noises from results searched through a search engine based on search expressions including information about specific products, technologies, applicants, and the like. In addition, the patent group includes only published patents, only registered patents, or a mixture thereof. In the case of the mixture thereof, the same or different weights may be given to the published patents and the registered patents. In operation S100, a patent group may be obtained through search expressions, or obtained using patent data (patent number and the like) stored in a user computer. Meanwhile, when a user manages a project for calculating a plurality of convergence indexes, at least one patent group corresponding to the project may be obtained for each project in operation S100.

Next, in operation S200, the method includes acquiring time information, a patent classification, and an industrial classification corresponding to the patent classification related to a patent included in the patent group.

The time information may be a reference date for calculating a convergence index, and include any one of the earliest date, a filing date, a publication date, and a registration date. The time information preferably uses the earliest date or the filing date as the reference date, and for the sake of accuracy, more preferably uses the date considered earliest in the priority claim as the reference date.

The patent classification may use international standard patent classifications such as IPC, or national standard patent classifications such as USPC. The patent classification has a depth of the patent classification in accordance with a patent classification system, and when using IPC, a subclass or main group level (depth) is preferably used. In addition, when using USPC, it is preferable that a class or a sub patent classification level of the class be used. The patent classification may use only a main classification, or may use a sub classification together with the main patent classification.

Industrial classification information may be standard industrial classification (SIC) or predetermined industrial classification.

Next, in operation S300, the method includes calculating a capability development index based on the time information and the patent classification which are acquired in operation S220. Specifically, the capability development index may be calculated using a capability score and a time score which are calculated based on the time information and the patent classification.

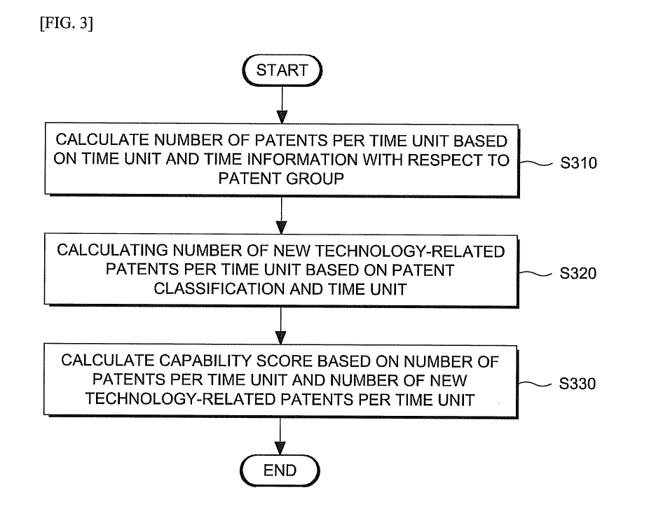

FIG. 3 is a flowchart showing an example of calculating a capability score in operation S300 according to an embodiment of the present invention.

Referring to FIG. 3, in operation S310, the number of patents per unit time is calculated based on unit time and time information with respect to the patent group. Specifically, the number of patents per unit time is calculated based on unit time (for example, year) with respect to the patent group including at least two patents.

Next, in operation S320, the number of patents per unit time is calculated based on unit time and the time information with respect to the patent group. Specifically, in order to calculate the number of new technology-related patents per unit time, when there is no patent based on a predetermined patent classification depth and then a patent appears at a specific time point T, it can be seen as appearance of new technology. For example, when an initial patent appears in a corresponding unit using a USPC class unit or an IPC subclass unit, it can be seen as appearance of new technology.

Next, in operation S330, the capability score is calculated based on the number of patents per unit time and the number of new technology-related patents per unit time. Specifically, a new technology score is first calculated based on the number of patents per unit time and the number of new technology-related patents per unit time.

The following Equation (1) is an example of a method for calculating a new technology score (DFDi) per year.

DFDi=NPi*Wp+NTi*Wt Equation (1

(DFDi: new technology score in year i, NPi: the number of patents per year, Wp: patent weights, NTi: the number of new technology-related patents, and Wt: technological (classification) weights)

Meanwhile, the new technology score may be calculated using a depreciation coefficient in consideration of technological obsolescence. The depreciation coefficient is obtained by reflecting a reduction in the value of technology over time in consideration of a life cycle of technology. Specifically, the new technology score may be calculated by multiplying the right hand side of Equation (1) by a depreciation coefficient of the corresponding year (depreciation coefficient α≦1).

Next, a technological cumulative score per year is calculated based on the calculated new technology score per year.

The following Equation (2) is an example of a method for calculating a technological cumulative score (CDFDi) per year.

CDFDi=DFDO+DFD1+DFD2+ . . . +DFDi-1+DFDi Equation (2)

(CDFDi: technological cumulative score per year, and DFDi: new technology score in year i)

Next, a capability score (FS) is calculated based on the technological cumulative score (CDFDi) per year.

The following Equation (3) is an example of a method for calculating the capability score (FS).

FS=(CDFDn−CDFDt-1)/(CDFDn) Equation (3)

(FS: capability score, CDFDn: technological cumulative score in entire year n, and CDFDn-CDFDt-1: technological cumulative score after time point t)

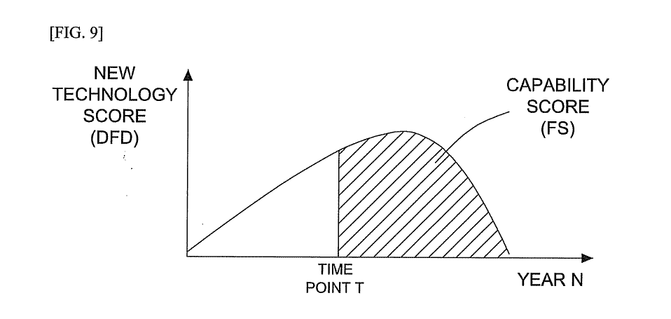

That is, the capability score (FS) may be defined as the ratio of the technological cumulative score (CDFDn-CDFDt-1) after the time point t to the technological cumulative score (CDFDn) in the entire year n as shown in FIG. 9.

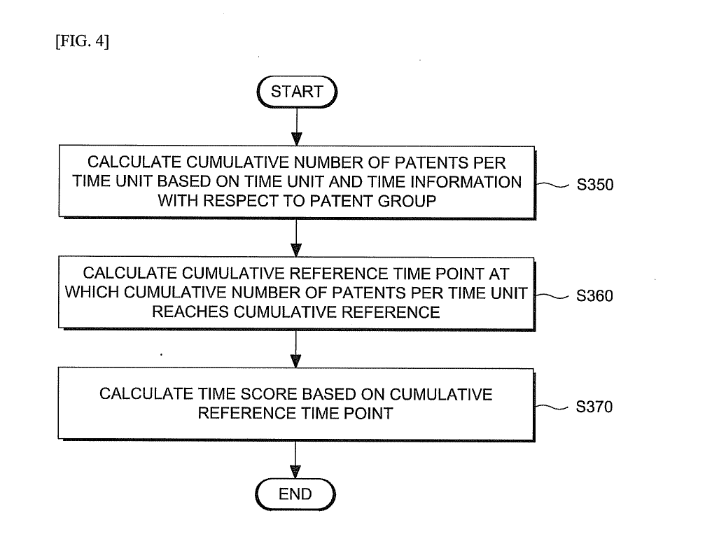

FIG. 4 is a flowchart showing an example of calculating a time score in operation S300 according to an embodiment of the present invention.

Referring to FIG. 4, in operation S350, the cumulative number of patents per unit time is calculated based on unit time and the time information with respect to the patent group. Next, in operation S360, a cumulative reference time point with respect to the cumulative number of patents per unit time is calculated. Next, in operation S370, a time score is calculated based on the cumulative reference time point.

The following Equation (4) is an example of a method for calculating a time score (TS).

TS=(n−k)/(n) Equation (4)

(TS: time score, n: entire period of time, and k: period of time until time point k)

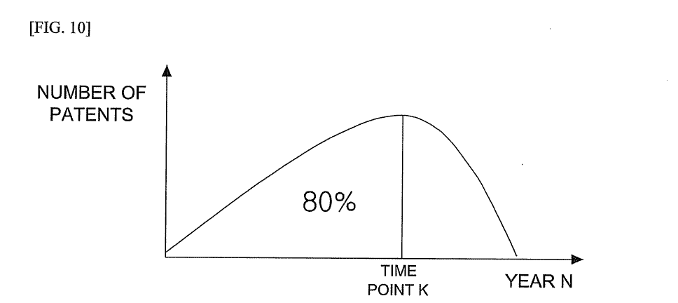

For example, the time point k may be set as a time point in which the cumulative number of patents is 80% of the total as shown in FIG. 10.

For the capability development of a convergence product, both a product launch time point and development types of the patents should be considered. Main patents with respect to the convergence product are generally registered before a corresponding product is launched, and when the product is launched, the number of registered patents is likely to be significantly reduced. Thus, an increase in the number of registered patents may denote an increase in the development potential of the corresponding capability and a reduction in the number of registered patents may denote a decline of the development potential. When the highest point (peak) of the number of patent applications associated with the convergence product occupies a specific position (for example, a position corresponding to 80%) of the total cumulative number of patents, the time score may be calculated as shown in Equation (4).

Finally, a capability development index may be calculated based on the capability score and the time score which are calculated in operations S310 to S380.

The following Equation (5) is an example of a method for calculating a capability development index (CI1).

CI1=FS*AFS+TS*ATS Equation (5)

(CI1: capability development index, FS: capability score, AFS: distribution of capability score, TS: time score, and ATS: distribution of time score)

Referring again to FIG. 2, in operation S400, a capability convergence index is calculated based on the patent classification acquired in operation S200. Specifically, the capability convergence index may be calculated using the capability convergence score and the service score which are calculated based on the patent classification.

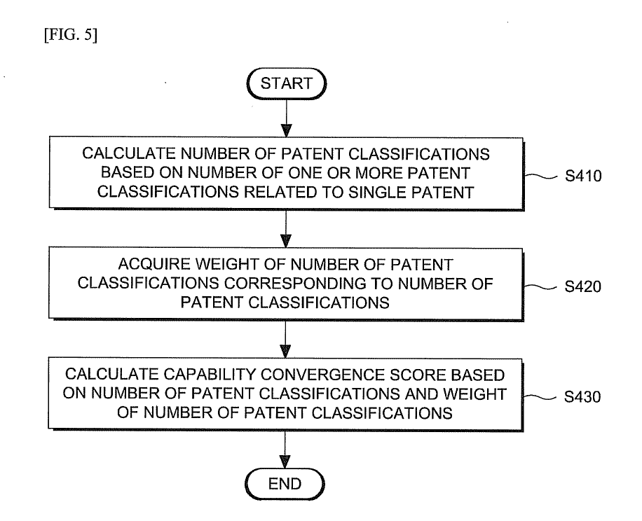

FIG. 5 is a flowchart showing an example of calculating a capability convergence score in operation S400 according to an embodiment of the present invention.

Referring to FIG. 5, in operation S410, the number of patent classifications is calculated based on the number of at least one patent classification related to a single patent.

Next, in operation S420, weights of the number of patent classifications corresponding to the number of patent classifications are acquired.

Next, in operation S430, a capability convergence score is calculated based on the number of patent classifications and the weights of the number of patent classifications.

The following Equation (6) is an example of a method for calculating a capability convergence score (FC).

FC=ACS*(WS/Σ(NCi))*1−exp(−Σ(NCi)/100)

(FC: capability convergence score, ACS: distribution of capability convergence score, Σ(NCi): sum of the number of patents in accordance with the number of patent classifications, WS=Σ(NCi*Wi): weighted sum of the number of patents in accordance with the number of patent classifications and the weights, NCi: the number of patents when the number of USPCs including patents is i or more, and Wi: weights when the number of USPCs including patents is i)

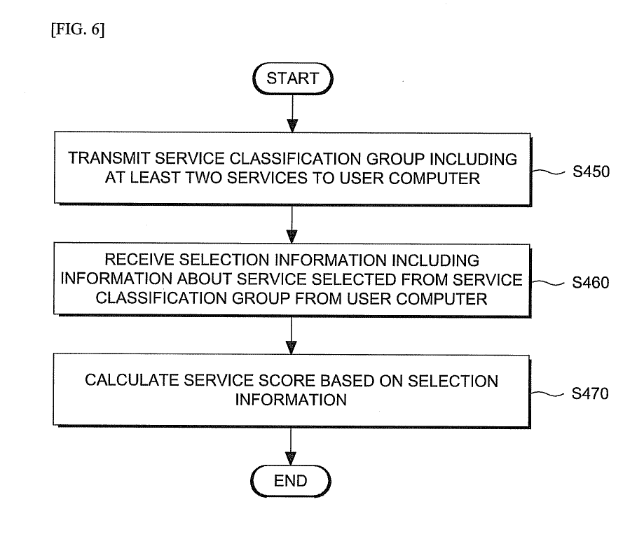

FIG. 6 is a flowchart showing an example of calculating a service score in operation S400 according to an embodiment of the present invention.

Referring to FIG. 6, in operation S450, a service classification group including at least two services is transmitted to a user computer.

Next, in operation S460, selection information including information about the service selected from the service classification group is received from the user computer.

Next, in operation S470, a service score is calculated based on the selection information. Specifically, the number of selected services may be handled as corresponding service information with reference to the selection information, and the service score may be created based on the corresponding service information. In this instance, the service score may be created using service weight information.

Finally, a capability convergence index may be calculated using the calculated capability convergence score and service score.

For example, the capability convergence index may be calculated based on distribution of each of the capability convergence score and the service score.

Referring again to FIG. 2, in operation S500, an industry relation index is calculated based on the patent classification and the industrial classifications which are acquired in operation S200. Specifically, the industry relation index may be calculated using a relation score of heterogeneous industries and a relation score of homogeneous industries which are calculated based on the patent classification and the industrial classification.

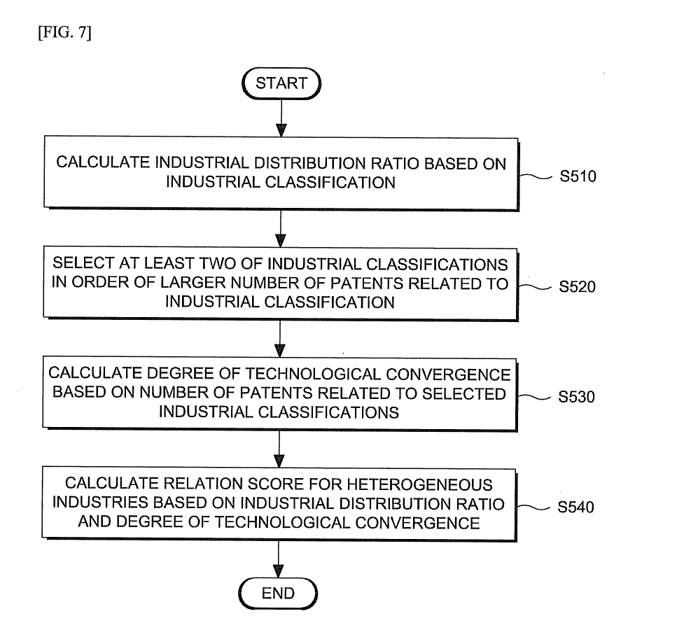

FIG. 7 is a flowchart showing an example of calculating a relation score of heterogeneous industries in operation S500 according to an embodiment of the present invention.

Referring to FIG. 7, in operation S510, an industrial distribution ratio based on the industrial classification. Specifically, the industrial classification is related to the patent classification in an industrial classification group such as SIC. The industrial distribution ratio may be calculated by dividing the number of industrial classifications by the total number of industrial classifications included in the industrial classification group. When the distribution ratio for each industry is high, the industry convergence potential is large, and when the related technologies are concentrated in a specific industry, the degree of technological convergence is high.

Next, in operation S520, at least two industrial classifications are selected in the order of larger number of patents related to the industrial classifications. In this instance, it is preferable that at least three industrial classifications be selected.

Next, in operation S530, the degree of technological convergence is calculated based on the number of patents related to the selected industrial classification. The degree of technological convergence may be calculated by dividing the number of patents related to the selected industrial classification by the total number of patents included in the patent group.

Next, in operation S540, a relation score of heterogeneous industries is calculated based on the industrial distribution ratio and the degree of technological convergence. For example, the relation of the heterogeneous industries is proportional to the industrial distribution ratio, but inversely proportional to the extent of technological convergence, and therefore the industrial distribution ratio may be divided into the degree of technological convergence to be calculated.

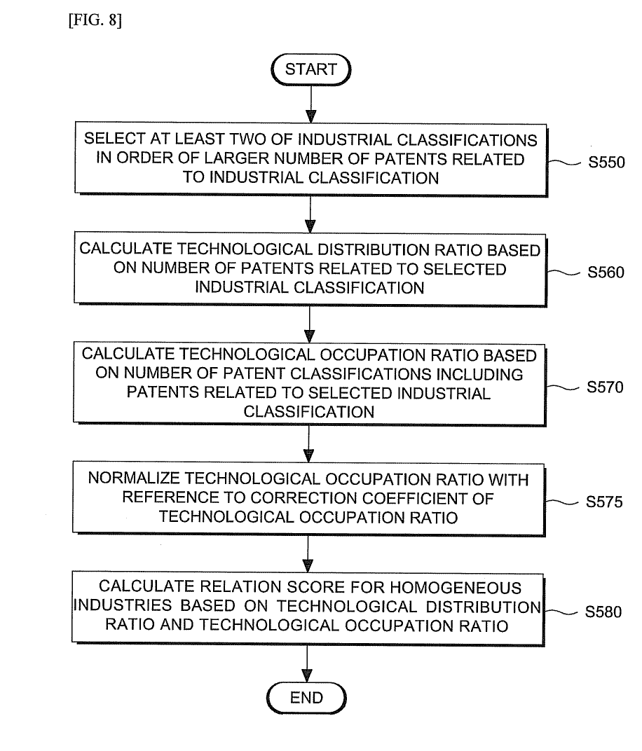

FIG. 8 is a flowchart showing an example of calculating a relation score of homogeneous industries in operation S500 according to an embodiment of the present invention.

Referring to FIG. 8, in operation S550, at least two industrial classifications are selected in the order of larger number of patents related to the industrial classification.

Next, in operation S560, a technological distribution ratio is calculated based on the number of patents related to the selected industrial classification. For example, the technological distribution ratio with respect to a first industrial classification may be calculated by dividing the number of patents related to a first corresponding industrial classification by the total number of patents included in the patent group.

Next, in operation S570, a technological occupation ratio is calculated based on the number of patent classifications including the patent related to the selected industrial classification. For example, the technological occupation ratio may be calculated by dividing the number of patent classifications including the patent related to the industrial classification by the total number of patent classifications which can be related to the industrial classification.

Next, in operation S575, the technological occupation ratio is normalized based on a correction coefficient of the technological occupation ratio.

The following Equation (7) is an example of a method for normalizing the technological occupation ratio.

NTSn=TSn*Kn Equation (7)

(NTSn: normalized technological occupation ratio, TSn: technological occupation ratio, and Kn: correction coefficient)
(Correction coefficient (Kn(n=2,3))=Kn−1*(sum of the number of middle classification patents of analysis set of Topn/sum of the number of patents for each middle classification patent of Top1)*TPn
Correction coefficient of first corresponding industrial classification K1=1
Correction coefficient of second corresponding industrial classification K2=K1*(the number of patent classifications including patents related to second corresponding industrial classification/the number of patent classifications that can be related to first corresponding industrial classification)*TP2
Correction coefficient of third corresponding industrial classification K3=K2*(the number of patent classifications including patents related to third corresponding industrial classification/the number of patent classifications that can be related to second corresponding industrial classification)*TP3)

In this instance, it is preferable that the correction coefficient be differently applied for each rank of corresponding industrial classifications.

Next, in operation S580, a relation score of homogeneous industries is calculated based on the technological distribution ratio and the normalized technological occupation ratio. For example, the relation score of homogeneous industries may be calculated by dividing an average of the normalized technological occupation ratios by a sum of distribution ratios for each industry.

Finally, the industry relation index may be calculated using the calculated relation score of heterogeneous industries and relation score of homogeneous industries. For example, the industry relation index may be calculated based on distribution of each of the relation score of heterogeneous industries and the relation score of homogeneous industries.

### Industrial Applicability

The present invention may be applied to measurement of the degree of convergence, estimation of convergence properties, calculate of convergence index, and services using these with respect to products or technologies or the related patent group.

In addition, the present invention may be used in systematically promoting convergence industry development.

Although a few embodiments of the present invention have been shown and described, it would be appreciated by those skilled in the art that changes may be made in this embodiment without departing from the principles and spirit of the invention, the scope of which is defined in the claims and their equivalents.

1. A method for calculating a convergence index by a convergence index service system configured to provide the convergence index to a user computer through a wired network or a wireless network, the method comprising:
(a) receiving a patent group including at least two patents from the user computer;
(b) acquiring time information, a patent classification and an industrial classification corresponding to the patent classification related to each of the at least two patents in the patent group;
(c) calculating a capability development index based on the time information and patent classification acquired in the step (b);
(d) calculating a capability convergence index based on the patent classification acquired in the step (b); and
(e) calculating an industry relation index based on the patent classification and the industrial classification acquired in the step (b),
wherein the step (e) includes calculating the industry relation index using a relation score of heterogeneous industries and a relation score of homogeneous industries calculated based on the patent classification and the industrial classification.

2. The method of claim 1, wherein the step (e) includes:
(e-1) calculating an industrial distribution ratio based on the industrial classification;
(e-2) selecting at least two of the industrial classification according to number of patents related to the industrial classification;
(e-3) calculating a degree of technological convergence based on the number of patents related to the industrial classifications selected in the step (e-2); and
(e-4) calculating the relation score of heterogeneous industries based on the industrial distribution ratio and the degree of technological convergence.

3. The method of claim 1, wherein the step (e) includes:
(e-5) selecting at least two of the industrial classification according to number of patents related to the industrial classification;
(e-6) calculating a technological distribution ratio based on the number of patents related to the industrial classification selected in the step (e-5);
(e-7) calculating a technological occupation ratio based on number of patent classifications including the patent related to the industrial classification selected in the step (e-5); and
(e-8) calculating the relation score of homogeneous industries based on the technological distribution ratio and the technological occupation ratio.

4. The method of claim 3, wherein the step (e-7) includes normalizing the technological occupation ratio based on a correction coefficient of the technological occupation ratio.

5. The method of claim 1, wherein the step (c) includes calculating the capability development index using a capability score and a time score calculated based on the time information and the patent classification.

6. The method of claim 5, wherein the step (c) includes:
(c-1) calculating number of patents per unit time for the patent group based on unit time and the time information;
(c-2) calculating number of new technology-related patents per unit time based on the patent classification and unit time; and
(c-3) calculating the capability score based on the number of patents per unit time and the number of new technology-related patents per unit time.

7. The method of claim 5, wherein the step (c) includes:
(c-4) calculating cumulative number of patents per unit time for the patent group based on unit time and the time information;
(c-5) calculating a cumulative reference time point related to the cumulative number of patents per unit time; and
(c-6) calculating the time score based on the cumulative reference time point.

8. The method of claim 1, wherein the step (d) includes calculating the capability convergence index using a capability convergence score and a service score calculated based on the patent classification.

9. The method of claim 8, wherein the step (d) includes:
(d-1) calculating number of the patent classification related to one of the at least two single patents;
(d-2) acquiring weights of the number of patent classification; and
(d-3) calculating the capability convergence score based on the number of patent classification and the weights of the number of patent classification.

10. The method of claim 8, wherein the step (d) includes:
(d-4) transmitting a service classification group including at least two services to the user computer;
(d-5) receiving selection information including information on a service selected from the service classification group from the user computer; and
(d-6) calculating the service score based on the selection information.

11. The method of claim 1, wherein the patent classification is determined according to a predetermined depth in a patent classification system including the patent classification.

12. The method of claim 11, wherein the capability development index is calculated based on a main patent classification of the patent classification, the capability convergence index is calculated based on a sub patent classification and the main patent classification, and the industry relation index is calculated based on the main patent classification.
